(19) United States
(12) Patent Application Publication
(10) Pub. No.: US 2023/0370573 A1
(43) Pub. Date: Nov. 16, 2023

(54) Door Integrated Motion Sensing, Illuminating, Image Capturing, And Communicating Assembly

(71) Applicant: Carmen Maddox, Country Club Hills, IL (US)

(72) Inventor: Carmen Maddox, Country Club Hills, IL (US)

(21) Appl. No.: 17/742,584

(22) Filed: May 12, 2022

(51) Int. Cl. H04N 7/18; H04M 1/02

(52) U.S. Cl. CPC H04N 7/188; H04M 1/0291; H04N 7/183

(57) ABSTRACT

A door integrated motion sensing, illuminating, image capturing, and communicating assembly for providing security for an egress opening includes a door, which is mountable in an egress doorframe of a structure. A control module, which comprises a transceiver, is attached to the door. A sensor, a set of bulbs, and a camera are attached to the door and are operationally engaged to the control module. The sensor can detect motion in an area that is external to the structure and proximate to the door. The sensor detects the motion and signals the control module, enabling the control module to selectively actuate the bulbs, the camera, and the transceiver, to illuminate the area, capture an image of the area, and to communicate an alert signal and the image, respectively, to an electronic device of a user.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to security assemblies and more particularly pertains to a new security assembly for providing security for an egress opening. The present invention discloses a security assembly comprising a door, which comprises an integral control module and to which a sensor, a set of bulbs, and a camera are engaged. The sensor detects the motion and signals the control module, which selectively actuates the bulbs and the camera to illuminate the area and to capture an image of the area, respectively. The control module also selectively actuates the transceiver to communicate an alert signal and the image to an electronic device of a user.

### Description of Related Art Including Information Disclosed Under 37 CFR 1.97 and 1.98.

The prior art relates to security assemblies. Prior art security assemblies may comprise doors with integral lighted windows or integral cameras, systems for sending video footage upon ringing of doorbells, systems for determining from which side doors are being opened, and motion sensing light fixtures. What is lacking in the prior art is a security assembly a door having an integral control module and to which a sensor, a set of bulbs, and a camera are engaged.

### (H) BRIEF SUMMARY OF THE INVENTION

An embodiment of the disclosure meets the needs presented above by generally comprising a door, which is configured to be mountable in an egress doorframe of a structure. A control module, which comprises a transceiver, is attached to the door. A sensor is attached to the door and is operationally engaged to the control module. The sensor is configured to detect motion in an area, which is external to the structure and proximate to the door. A set of bulbs is attached to the door and is operationally engaged to the control module. The bulbs are configured to selectively illuminate the area. A camera is attached to the door, is operationally engaged to the control module, and is positioned to selectively capture an image of the area. The sensor is configured to detect the motion and to signal the control module, enabling the control module to selectively actuate the bulbs and the camera to illuminate the area and to capture an image of the area, respectively. The control module also selectively actuates the transceiver to communicate an alert signal and the image to an electronic device of a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a front view of a door integrated motion sensing, illuminating, image capturing, and communicating assembly according to an embodiment of the disclosure.

FIG. 2 is a rear view of an embodiment of the disclosure.

FIG. 3 is a side view of an embodiment of the disclosure.

FIG. 4 is a side view of an embodiment of the disclosure.

FIG. 5 is a cross-sectional view of an embodiment of the disclosure.

### (J) DETAILED DESCRIPTION OF THE INVENTION

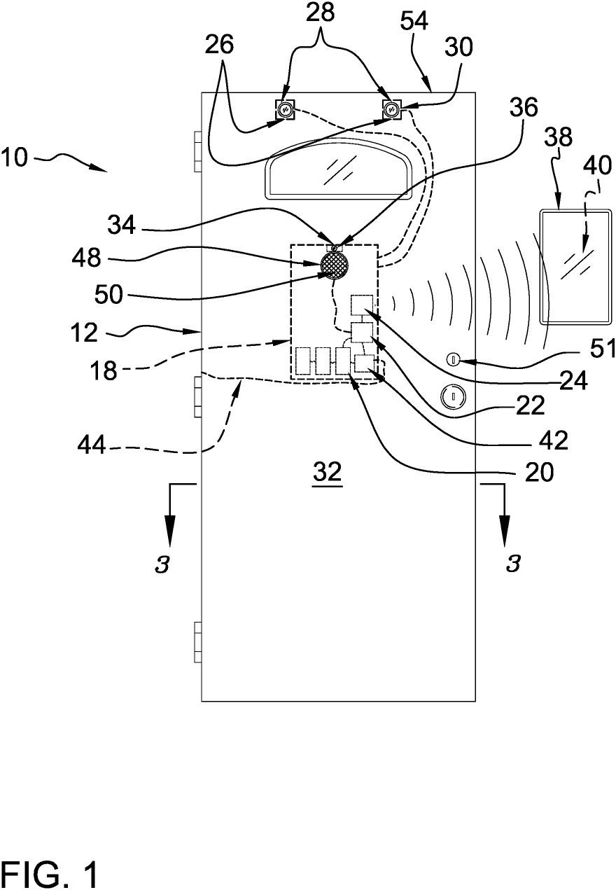

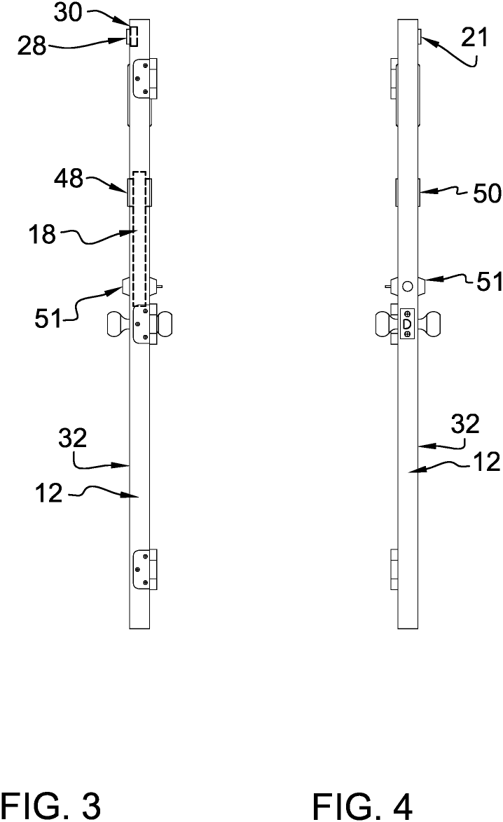

With reference now to the drawings, and in particular to FIGS. 1 through 5 thereof, a new security assembly embodying the principles and concepts of an embodiment of the disclosure and generally designated by the reference numeral 10 will be described.

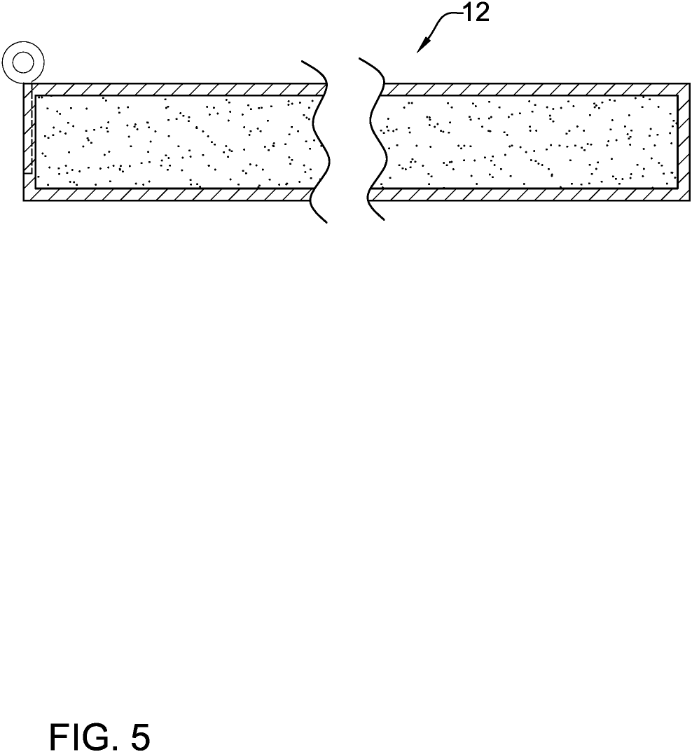

As best illustrated in FIGS. 1 through 5, the door integrated motion sensing, illuminating, image capturing, and communicating assembly 10 generally comprises a door 12, which is configured to be mountable in an egress doorframe 14 of a structure 16. The door 12 may comprise an exterior door, a storm door, a security screen door, or the like. In one example, as shown in FIG. 5, the door 12 comprises insulation and aluminum cladding.

A control module 18, which is attached to the door 12, comprises a battery 20, which is rechargeable, a microprocessor 22 and a transceiver 24. The microprocessor 22 is operationally engaged to the battery 20 and to the transceiver 24.

A sensor 26 is attached to the door 12 and is operationally engaged to the control module 18. The sensor 26 is configured to detect motion in an area that is external to the structure 16 and proximate to the door 12. Sensors for detecting motion are well known to those skilled in the art of motion sensing and these anticipated by the present invention. Such sensors may comprise passive infrared sensors, ultrasonic sensors, tomographic sensors, and the like.

A set of bulbs 28 is attached to the door 12 and is operationally engaged to the control module 18. The bulbs 28 are configured to selectively illuminate the area. Each bulb 28 may comprise of at least one light emitting diode 30, although the present invention also anticipates the bulb 28 being incandescent, fluorescent, and the like. The set of bulbs 28 may comprise two bulbs 28, which are positioned proximate to a top 54 of the door 12 on an outer surface 32 of the door 12, as shown in FIG. 1. The present invention also anticipates other numbers of bulbs 28, such as, but not limited to, one bulb 28, three bulbs 28, and the like, as well as other positioning of the bulbs 28 on or proximate to the door 12. The present invention further anticipates each bulb 28 comprising an integral sensor 26.

A camera 34 is attached to the door 12, is operationally engaged to the control module 18, and is positioned to selectively capture an image of the area. The camera 34 is configured to capture video and may comprise a wide angle lens 36.

The sensor 26 is configured to detect the motion in the area proximate to the door 12 and to signal the control module 18, enabling the control module 18 to selectively actuate the bulbs 28 and the camera 34 to illuminate the area and to capture an image of the area, respectively. The control module 18 also selectively actuates the transceiver 24 to communicate an alert signal and the image to an electronic device 38 of a user, such as a smartphone, tablet, computer, or the like. Programming code 40 selectively positionable on the electronic device 38 of the user enables the electronic device 38 to receive and to sound the alert signal and to receive and to display the image.

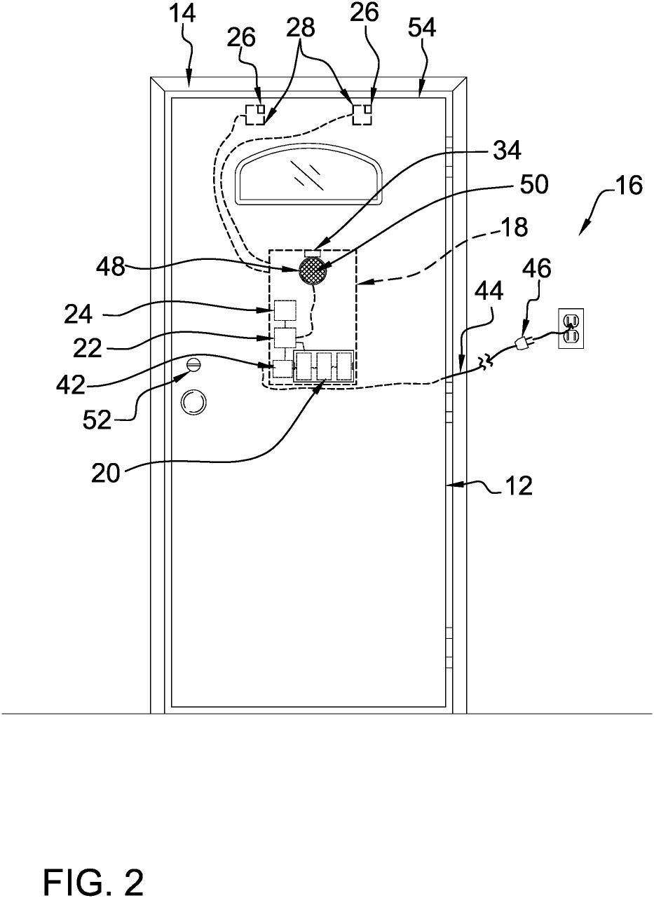

The control module 18 also comprises a power supply unit 42, which is operationally engaged to the battery 20 and to the microprocessor 22. The power supply unit 42 is configured to convert alternating current to direct current. A power cord 44 is operationally engaged to and extends from the power supply unit 42. A plug 46 of the power cord 44 is configured to operationally engage the power supply unit 42 to a source of electrical current to charge the battery 20, as shown in FIG. 2.

A speaker 48 and a microphone 50 are operationally engaged to the control module 18 and are positioned on the outer surface 32 of the door 12. The speaker 48 is configured to broadcast an incoming audio signal. The microphone 50 is configured to convert sound proximate to the door 12 to an outgoing audio signal. The programming code 40 positioned on the electronic device 38 of the user enables two way communication between the user and a person proximate to the control module 18 via the transceiver 24, the speaker 48, and the microphone 50. The present invention also anticipates the programming code 40 enabling recording of the images on the electronic device 38.

The present invention also anticipates the door integrated motion sensing, illuminating, image capturing, and communicating assembly 10 being interfaced with a controlled entry assembly (not shown, but being integral to the door 12) for controlling access to the structure 16. In that manner, the user would be able to remotely unlock a lock 52 of the door 12 to allow entry to a person who they are viewing via the camera 34 or speaking with via the speaker 48 and the microphone 50.

In use, the sensor 26 detects the motion and signals the control module 18. The control module 18 selectively actuates the bulbs 28 and the camera 34 to illuminate the area and to capture an image of the area, respectively. The control module 18 also selectively actuates the transceiver 24 to communicate an alert signal and the image to an electronic device 38 of a user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A door integrated motion sensing, illuminating, image capturing, and communicating assembly comprising:
a door configured to be mountable in an egress doorframe of a structure;
a control module comprising a transceiver attached to the door;
a sensor attached to the door and operationally engaged to the control module, the sensor being configured for detecting motion in an area, the area being external to the structure and proximate to the door;
a set of bulbs attached to the door and operationally engaged to the control module, such that the bulbs are configured for selectively illuminating the area; and
a camera attached to the door, operationally engaged to the control module, and being positioned for selectively capturing an image of the area, wherein the sensor is configured for detecting the motion and signaling the control module, enabling the control module for selectively actuating the bulbs, the camera, and the transceiver for illuminating the area, capturing an image of the area, and communicating an alert signal and the image, respectively, to an electronic device of a user.

2. The door integrated motion sensing, illuminating, image capturing, and communicating assembly of claim 1, wherein the control module comprises:
a battery; and
a microprocessor operationally engaged to the battery and the transceiver.

3. The door integrated motion sensing, illuminating, image capturing, and communicating assembly of claim 2, further including:
the battery being rechargeable;
the control module comprising a power supply unit operationally engaged to the battery and the microprocessor, the power supply unit being configured for converting alternating current to direct current; and
a power cord operationally engaged to and extending from the power supply unit,
wherein a plug of the power cord is configured for operationally engaging the power supply unit to a source of electrical current for charging the battery.

4. The door integrated motion sensing, illuminating, image capturing, and communicating assembly of claim 1, wherein each bulb comprises of at least one light emitting diode.

5. The door integrated motion sensing, illuminating, image capturing, and communicating assembly of claim 1, wherein the set of bulbs comprises two bulbs positioned proximate to a top of the door on an outer surface of the door.

6. The door integrated motion sensing, illuminating, image capturing, and communicating assembly of claim 1, wherein the camera is configured for capturing video.

7. The door integrated motion sensing, illuminating, image capturing, and communicating assembly of claim 1, wherein the camera comprises a wide angle lens.

8. The door integrated motion sensing, illuminating, image capturing, and communicating assembly of claim 2, further including programming code selectively positionable on the electronic device of the user enabling the electronic device for receiving and sounding the alert signal and for receiving and displaying the image.

9. The door integrated motion sensing, illuminating, image capturing, and communicating assembly of claim 8, further including:
a speaker operationally engaged to the control module and positioned on an outer surface of the door, wherein the speaker is configured for broadcasting an incoming audio signal;
a microphone operationally engaged to the control module and positioned on the outer surface of the door, wherein the microphone is configured for converting sound proximate to the door to an outgoing audio signal; and
the programming code enabling two way communication between the user and a person proximate to the control module via the transceiver, the speaker, and the microphone.

10. A door integrated motion sensing, illuminating, image capturing, and communicating system comprising:
a structure having an egress doorframe;
a door mounted in the egress doorframe;
a control module comprising a transceiver attached to the door;
a sensor attached to the door and operationally engaged to the control module, the sensor being configured for detecting motion in an area, the area being external to the structure and proximate to the door;
a set of bulbs attached to the door and operationally engaged to the control module, such that the bulbs are configured for selectively illuminating the area;
a camera attached to the door, operationally engaged to the control module, and being positioned for selectively capturing an image of the area, wherein the sensor is configured for detecting the motion and signaling the control module, enabling the control module for selectively actuating the bulbs, the camera, and the transceiver for illuminating the area, capturing an image of the area, and communicating an alert signal and the image;
an electronic device of a user; and
programming code positioned on the electronic device enabling the electronic device for receiving and sounding the alert signal and for receiving and displaying the image.

11. A door integrated motion sensing, illuminating, image capturing, and communicating assembly comprising:
a door configured to be mountable in an egress doorframe of a structure;
a control module comprising a transceiver attached to the door, the control module comprising:
a battery, the battery being rechargeable,
a microprocessor operationally engaged to the battery and the transceiver,
a power supply unit operationally engaged to the battery and the microprocessor, the power supply unit being configured for converting alternating current to direct current;
a power cord operationally engaged to and extending from the power supply unit,
wherein a plug of the power cord is configured for operationally engaging the power supply unit to a source of electrical current for charging the battery;
a sensor attached to the door and operationally engaged to the control module, the sensor being configured for detecting motion in an area, the area being external to the structure and proximate to the door;
a set of bulbs attached to the door and operationally engaged to the control module, such that the bulbs are configured for selectively illuminating the area, each bulb comprising at least one light emitting diode, the set of bulbs comprising two bulbs positioned proximate to a top of the door on the outer surface;
a camera attached to the door, operationally engaged to the control module, and being positioned for selectively capturing an image of the area, wherein the sensor is configured for detecting the motion and signaling the control module, enabling the control module for selectively actuating the bulbs, the camera, and the transceiver for illuminating the area, capturing an image of the area, and communicating an alert signal and the image, respectively, to an electronic device of a user, the camera being configured for capturing video, the camera comprising a wide angle lens; and
a speaker operationally engaged to the control module and positioned on an outer surface of the door, wherein the speaker is configured for broadcasting an incoming audio signal;
a microphone operationally engaged to the control module and positioned on the outer surface of the door, wherein the microphone is configured for converting sound proximate to the door to an outgoing audio signal;
programming code selectively positionable on the electronic device of the user enabling the electronic device for receiving and sounding the alert signal and for receiving and displaying the image, the programming code enabling two way communication between the user and a person proximate to the control module via the transceiver, the speaker, and the microphone.
